(19) United States
(12) Patent Application Publication
(10) Pub. No.: US 2013/0173205 A1
(43) Pub. Date: Jul. 4, 2013

(54) THERMAL ENERGY METERING BY MEASURING AVERAGE TANK TEMPERATURE

(71) Applicant: Arnoud VAN HOUTEN, Reston, VA (US)

(72) Inventor: Arnoud VAN HOUTEN, Reston, VA (US)

(73) Assignee: Sunnovations LLC, McLean, VA (US)

(21) Appl. No.: 13/453,556

(22) Filed: Apr. 23, 2012

Related U.S. Application Data
(60) Provisional application No. 61/582,642, filed on Jan. 3, 2012.

(51) Int. Cl. G06F 15/00; G01K 7/00; G01K 17/08; F24H 7/00; F24J 2/04

(52) U.S. Cl. 702/136; 122/13.01; 126/640; 374/165; 374/E07.001

(57) ABSTRACT

Apparatus and methods are provided for thermal energy metering by measuring the average temperature of fluid in a tank, such as a hot water storage tank. Average temperature is measured with an elongated temperature sensor spanning the vertical height of the tank. A controller collects measurements from the temperature sensor and computes changes in thermal energy, from which the system can more accurately attribute gains of thermal energy to sources such as thermal, electric, or gas production, or losses of thermal energy to ambient losses and consumption.

### CROSS-REFERENCE TO RELATED APPLICATIONS

This application claims priority under 35 U.S.C. §119(e) to provisional application Ser. No. 61/582,642, entitled Thermal Energy Metering by Measuring Average Tank Temperature, filed Jan. 3, 2012, which is incorporated herein by reference.

### BACKGROUND

A thermal energy metering system can measure thermal energy transferred to and from a liquid by using a flow meter and two temperature sensors. For example, this system can measure thermal energy transferred to liquid in a storage tank via a heat exchanger. One technique for improving the accuracy of this measurement is through the use of a flow meter and in-flow temperature sensors (see, e.g., U.S. Pat. No. 7,520,445). However, this technique may be too expensive for residential solar thermal systems or other cost-sensitive systems. Furthermore, this technique may be inaccurate in systems where the flow is low or highly variable, as in passive geyser pumped solar systems, as shown, for example, in U.S. Pat. No. 7,798,140, entitled Adaptive Self Pumping Solar Hot Water Heating System with Overheat Protection.

### BRIEF SUMMARY

The present disclosure relates to apparatus and methods for metering thermal energy by measuring average fluid temperature in a tank with an elongated sensor. In particular, apparatus and methods are provided for achieving accurate thermal metering of hot water systems at a low cost.

For example, in one embodiment, an apparatus comprises a hot water storage tank; a temperature sensor connected to the hot water storage tank, wherein the temperature sensor is vertically oriented within the hot water storage tank; a first sensor terminal connected to a first end of the temperature sensor; a second sensor terminal connected to a second end of the temperature sensor opposite from the first end; and a controller forming an electrical circuit with the first and second sensor terminals for processing measurements from the temperature sensor.

In another embodiment, a computer-based method comprises measuring a first average fluid temperature in a hot water storage tank with a temperature sensor at a first time, wherein the temperature sensor is vertically oriented within the hot water storage tank; measuring a second average fluid temperature in the hot water storage tank with the temperature sensor at a second time of the sensor; calculating a rate of change of average temperature of the fluid in the hot water storage tank based on the first and second average fluid temperatures and the first and second times; and calculating a change in thermal energy in the fluid in the hot water storage tank based on the calculated rate of change of average temperature of the fluid.

Other features and advantages will become apparent from the following detailed description and drawings.

### BRIEF DESCRIPTION OF THE DRAWINGS

FIG. 1 is a schematic representation of an apparatus with a standard hot water storage tank with cold water inlet and hot water outlet, with a heat exchanger, and an elongated sensor schematically shown along the vertical dimension of the tank.

FIG. 2 is a block diagram of an apparatus similar to that shown in FIG. 1, further representing a controller and processor readable medium for controlling the apparatus and recording measurements.

FIG. 3 is a flow diagram of a method, describing the steps of measuring thermal energy and calculating changes in thermal energy based on average temperature in a hot water storage tank.

### DETAILED DESCRIPTION OF THE INVENTION

This disclosure describes passive low cost systems and methods for metering thermal energy by accurately measuring the changes in average temperature in a storage tank. A benefit of the systems and methods described is that one can meter production and consumption of thermal energy with the same sensor, and the metering can be performed simultaneously and instantaneously, whereas flow meter based systems can require separate flow meters in the production and load side, thus increasing the cost and complexity of this type of system.

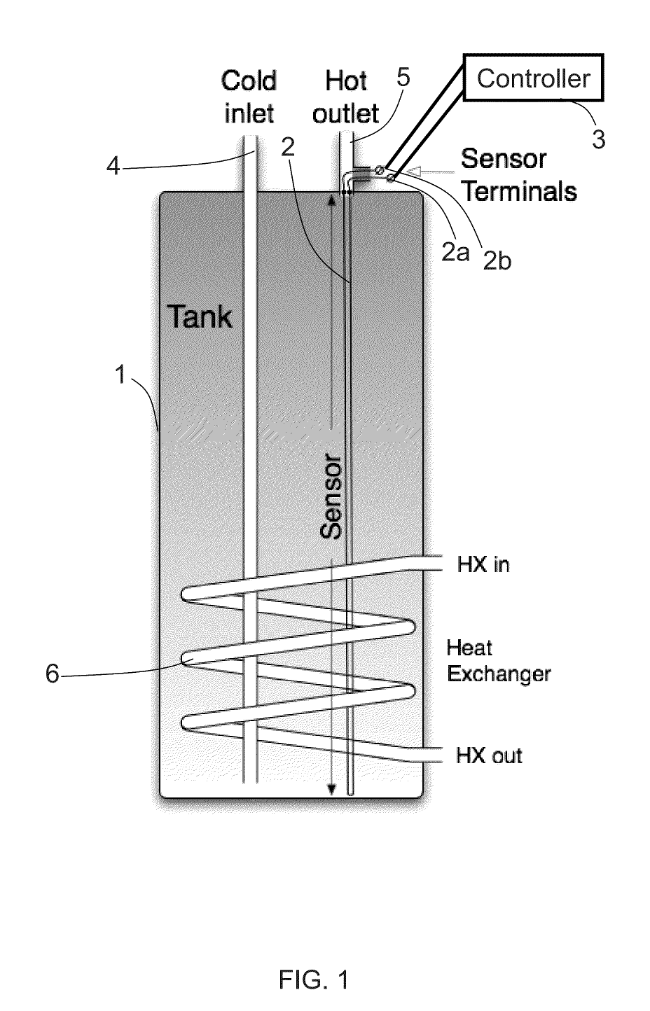

Referring to FIG. 1, exemplary embodiments have a hot water storage tank 1. The tank 1 can have a cold water inlet 4 and hot water outlet 5. An immersed heat exchanger system 6 is present inside the tank 1 to deliver thermal energy from solar or backup sources such as electric or gas (not shown). An elongated temperature sensor 2 is depicted extending along a significant part of the vertical length of the tank 1. In some embodiments, a sensor interface is formed by a first sensor terminal 2a and a second sensor terminal 2b extending from a port on tank 1 such as hot water outlet 5. The sensor terminals 2a and 2b form an electrical circuit with a controller 3, which is depicted in block diagram form. In some embodiments, one or more electrical heating elements can be in the tank (not shown), and the sensor 2 can measure the thermal energy input from the electrical elements.

When thermal energy is transferred to fluid in a storage tank 1, the average temperature of the fluid in the tank will rise. One example is a solar hot water system that collects thermal solar energy via collectors and stores the thermal energy in fluid in storage tank 1 for later use. The change in average temperature increase over a certain time period is directly proportional to the amount of energy transferred to the fluid in tank 1:

Q=m·Cₚ·ΔT, where
Q is the amount of heat lost or gained measured in, e.g., Joules,
m is the mass of the fluid in the storage tank (a known amount for a particular tank) measured in, e.g., kilograms,
Cₚis the heat capacity of the fluid (e.g., approximately 4.183 J/g·K for liquid water at typical operating temperatures and pressure), and
ΔT is the change in temperature (e.g., average tank temperature) over the measurement period measured in, e.g., degrees Kelvin.

In some embodiments, the volume of the tank is known, but the mass of the fluid in the tank changes due to thermal expansion of the fluid. For example, if the temperature of fluid in a 300 L tank rises from 5° C. to 85° C., approximately 5 L of fluid would be displaced. In the systems and methods described here, thermal expansion can be taken into account to convert between volume and mass based on temperature to improve the accuracy of calculating transfer of thermal energy. Similarly, some embodiments can be calibrated accurately by looking up an appropriate Cₚvalue for a given tank temperature.

In the systems and methods described here, a single elongated sensor 2 placed vertically inside the tank 1 and having substantially similar height as tank 1 is used to measure the average temperature of fluid in the tank. Controller 3 is then used to determine the source of the change in thermal energy. For example, thermal energy may be added to the fluid through, e.g., solar or backup electrical or gas thermal energy generators, or thermal energy may be taken from the fluid through, e.g., hot water consumption through hot water outlet 5 or ambient leakage of heat to the surrounding environment. The computer-based process may determine that the change in thermal energy was due to a combination of some thermal energy production and some thermal energy production. In particular, ambient heat loss is a likely to be a continuous source of a partial reduction in thermal energy.

In some embodiments, the apparatus and methods allow a sensor to be retrofitted to existing tank 1 easily using an existing port in the tank such as hot water outlet 5.

The sensor 2 can take advantage of the physical property that the electrical resistance of materials (e.g., metals, semiconductors, etc.) changes proportionally to temperature changes in that material. The resistivity of an elongated temperature sensor 2 changes proportionally to the average temperature changes in that material. A sensor 2 that covers substantially the entire vertical height of tank 1 from bottom to top can measure the average temperature of the fluid in the tank, even if the temperature difference between bottom and top is large and the stratification is non-linear. For instance, a layer of hot fluid above a layer of cold water has an average temperature measurable by the elongated sensor 2.

An embodiment for this sensor 2 can be a metal wire in an elongated “U” shape, as shown. However, even if a thin wire is used, the resistance can be less than 1 ohm. The changes in resistance would thus measure in milliohms. Such granularity could require expensive measurement electronics and can be inaccurate due to changes introduced by the measurement electronics (e.g., resistive changes in the connecting wires and terminals).

Thus, another embodiment includes a thin sensor wire wound in a long coil or folded together multiple times to produce a higher average resistance, e.g., greater than 50 ohms, or greater than 100 ohms, or greater than 150 ohms, or greater than 200 ohms and higher average changes in resistance for a given change in temperature. Therefore, relatively small temperature changes produce relatively large resistance changes that are easier to measure accurately than changes produced in a resistive sensor with a lower average resistance, while the effects of variations in resistance of sensor interface such as sensor terminals 2a and 2b and wires connecting the circuit between the sensor interface and the controller 3 become increasingly negligible and are substantially eliminated. A sensor wire can have a very thin electrical insulation layer around it, which can still respond quickly to temperature changes.

One implementation is the use of flexible printed circuit board with a finely etched copper-wire pattern. Yet another implementation is the use of a flexible thin-film metal, carbon, semiconducting or other conducting or semiconducting material strip, such as a graphite tape. A small weight can be placed at the bottom of the sensor 2 to ensure that the sensor hangs vertically within the fluid inside the tank. The sensor 2 could be placed on the outside and thermally coupled to the wall of tank 1 inside an insulation layer, in which case some additional compensation could be required in the determination of temperature change.

A thin electrical insulation layer can be added around sensor 2 to protect it from galvanic corrosion inside tank 1. A flexible sensor 2 makes it easy to lower it into tank 1 via an existing port on the top of tank 1, e.g., by using a T-fitting at hot water outlet 5.

Sensor 2 extends substantially the length of tank 1 to compensate for stratification, i.e., higher or lower temperatures within layers of fluid above or below the extent of the elongated sensor. Thus, for more accurate measurements, sensor 2 should extend through at least about 80 percent, or greater than 85 percent, or greater than 90 percent, or greater than 95 percent of a linear dimension of tank 1 (i.e., the vertical height of tank 1 when tank 1 has been installed).

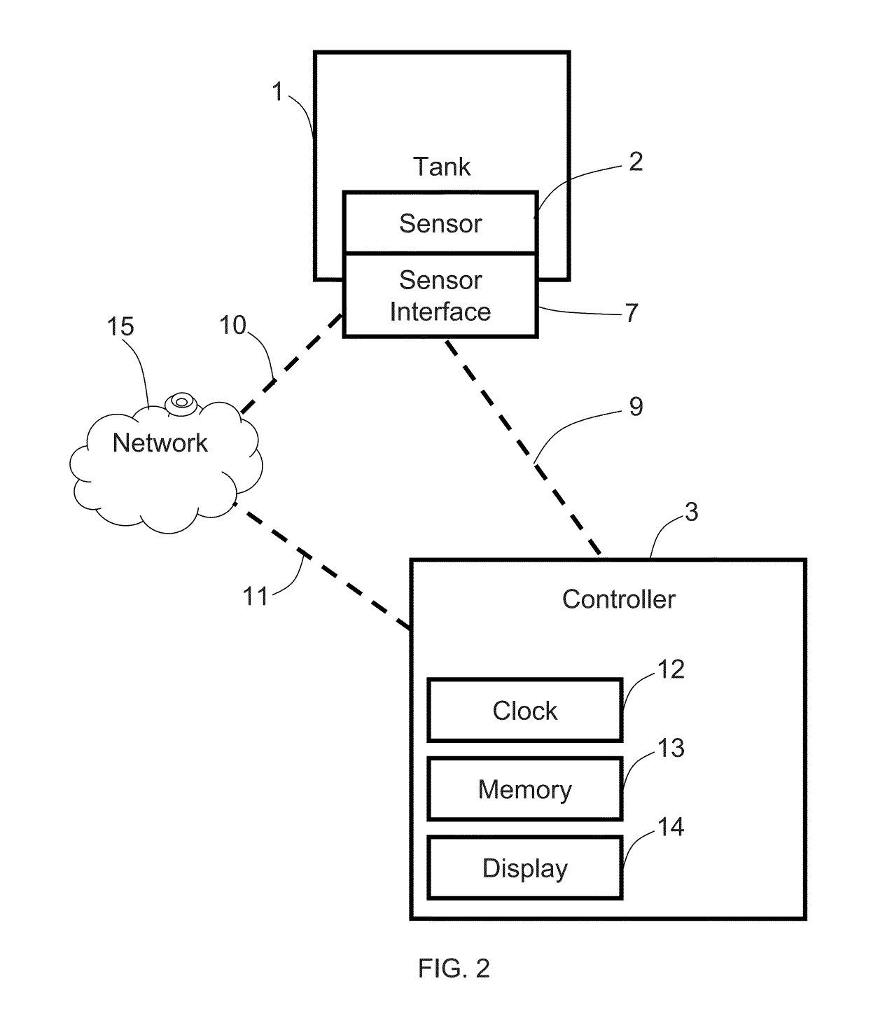

Referring to FIG. 2, tank 1 contains sensor 2. Sensor 2 communicates with controller 3 through sensor interface 7. In some embodiments, controller 3 interfaces with sensor 2 over a network 15 via wired or wireless connections 10 and 11. In other embodiments, controller 3 forms a direct current (DC) or alternating current (AC) circuit with sensor interface 7. Controller 3 can include a clock 12 for measuring time intervals or current local time, a processor readable medium such as memory 13 for storing measurements or calculations, and a display 14 for displaying data such as recent measurements or calculations. Display 14 can be a digital display, analog gauge, interactive touch screen, or any visual means for conveying data.

The thermal energy production and consumption can be metered with a single elongated temperature sensor 2 in tank 1. A controller 3 (e.g., microcontroller, microprocessor, etc.) forming an electrical circuit with the temperature sensor 2 can process measurements from the sensor 2 at periodic intervals. The intervals may be fixed frequencies, such as one measurement per second, per two seconds, per five seconds, or per ten seconds, etc., as desired.

The controller 3 can be connected to memory 13, e.g., a volatile or non-volatile processor readable medium for storing data such as the periodic measurements or the rates of changes in thermal energy based on the change in temperature over a time period, or a non-volatile processor readable medium for storing data or instructions configured to perform the steps of the new methods. Controller 3 can be configured to receive updates such as firmware updates via tangible media or via network 15.

While the description refers to the use of a “controller,” or “microcontroller,” these terms should be understood broadly to include any form of processing. For example, a dedicated processor could be used, or the measurements could be provided by a general or special purpose computer that has, as one of its tasks, the task of periodically measuring the resistance of temperature of the sensor and determining changes in thermal energy. The controller or processor can thus include application-specific integrated circuitry, programmable logic, microprocessors, or groups of computers. The measurements can be performed in hardware or in software, and the software (i.e., instructions) can be on a non-transitory, tangible medium, such as solid state memory, magnetic memory, optical memory, or any other tangible medium for a computer program. The microcontroller would be coupled to the sensor terminals shown in FIG. 2. Data could be collected at the tank and then sent to a remote system for further processing, such as through wired or wireless communication protocols. An analog meter could be used to show average temperature of fluid in the tank directly, or it could be used to show the energy stored in the tank, analogous to showing the energy available in a battery.

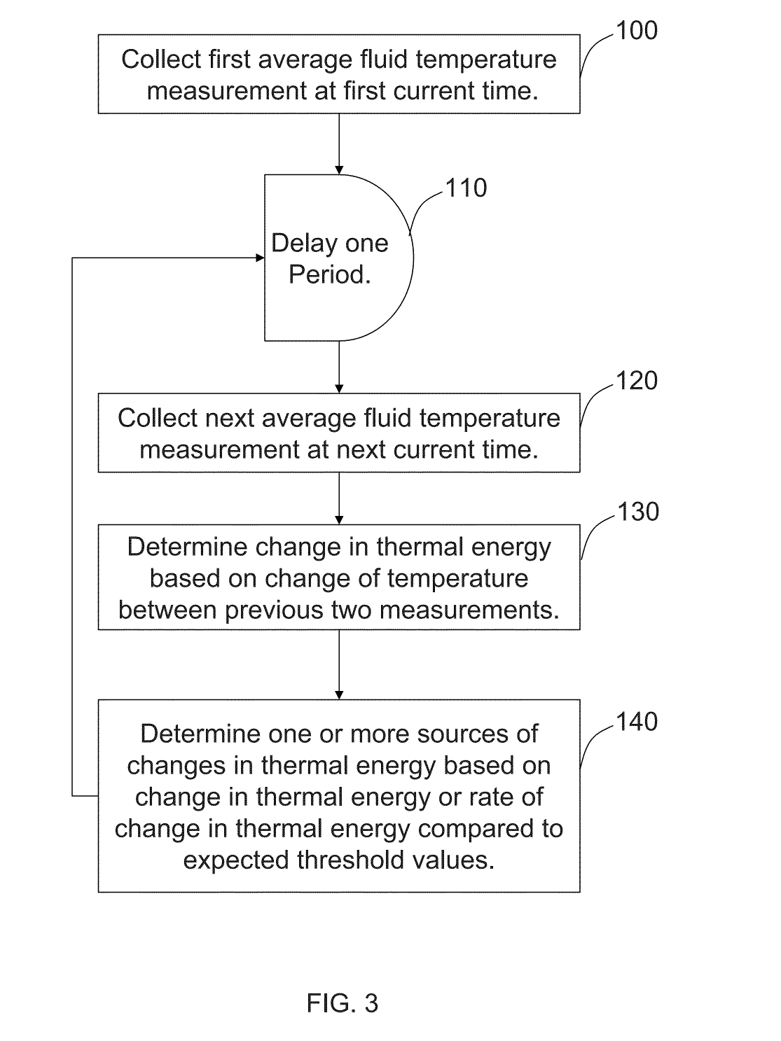

Referring to FIG. 3, an exemplary method collects a first temperature measurement at a first current time at Step 100. The system enters a loop, waiting for the duration of one period to pass at Step 110 and collecting another temperature measurement at the next current time at Step 120. The system can process at least the previous two temperature measurements and compute a corresponding change in thermal energy over that time period at Step 130. The system can compute one or more sources of changes in thermal energy at Step 140 based on the change in thermal energy (or rate of change of thermal energy) calculated at Step 130 by, e.g., comparing the change in thermal energy to threshold values for various sources of changes in thermal energy. The system can also store or transmit any type of data (e.g., temperature and time measurements, thermal energy calculations, thermal energy source attributions, etc.) during or after any step.

In some embodiments, the system computes the sources of changes in thermal energy based on the previous measurements at Step 140 and then returns to Step 110 to wait for the current period to elapse and collect another measurement. In other embodiments, such as in systems with parallel processing capabilities, they system loops over Steps 110 and 120 continuously while simultaneously looping over Steps 130 and 140 to process the data from memory as it is collected. In other embodiments, the system loops over Steps 110 and 120 for a number of periods over a course of time such as an hour, a day, or a month, and then transmits a collection of measurements over a wired or wireless network to a collocated or remotely located part of the system that subsequently loops over Steps 130 and 140 to process the collection of measurements.

The system can be further configured to determine whether a particular measurement is erroneous because, for example, it appears to be an outlier. The system can discard measurements determined to be erroneous and use the measurements preceding and following the discard measurement to compute more accurate changes in thermal energy at Step 130.

Relatively frequent metering of relatively small temperature changes over short time intervals at Steps 110 and 120 allow the system to compute the thermal energy delivered to or taken from the tank nearly instantaneously at Step 130. The total amount of thermal energy delivered to the tank in a given time period can also be tracked over regular time intervals, e.g., per hour or day, thus allowing metering of solar thermal production in a given time interval, e.g., on a given day.

The system can also determine whether thermal energy is supplied from solar or backup (e.g., electrical or gas heating) sources by analyzing the rate of change in average temperature of the fluid in the tank as measured by the temperature sensor at Step 140. A relatively slow and small increase can be attributed to solar contribution, whereas a relatively fast and large increase can be attributed to backup sources or a combination of solar and backup sources.

Similarly, a relatively slow and small decrease can be attributed to ambient thermal energy losses. A relatively fast and large increase can be attributed to hot water consumption or a combination of hot water consumption and ambient losses. In some embodiments, the system can learn what the typical energy loss is at given tank and ambient temperatures so it can be used to adjust the proportion of thermal energy contribution or consumption attributable to heating sources or hot water consumption, respectively, at Step 140.

Additionally, the system can also determine if hot water production and consumption takes place at the same time based on the typical rates of change in sensor resistance or temperature attributable to production or consumption alone at Step 140. For example, in some embodiments, a change in thermal energy can be attributed in part to a solar or backup heating contribution and another part to hot water consumption or ambient losses.

The data that is derived from the rate of change of thermal energy of the fluid in the tank at Steps 130 and 140 can be used for monitoring purposes to make sure that the hot water system is functioning properly, for monitoring for statistical purposes, and for monitoring for billing or metering purposes.

In the case for monitoring for proper functioning, one of more thresholds could be established to determine whether a parameter has changed by a significant enough amount that would warrant attention to the system. Thus, the processor could compare incoming data to one or more thresholds and provide an alert or alarm if, for example, the measured average temperature, the computer rate of change of average temperature, or the computed rate of change of thermal energy falls above or below a specified threshold or falls outside a specified range.

The alert can be transmitted (e.g., over network 15) to any recipient. For example, in some embodiments, the alert can be transmitted to a system owner, a temperature sensor system vendor, or a solar system installer who can schedule a maintenance visit based on the alert.

For other forms of monitoring, the data that is generated can be compared to other data that is used for other forms of providing thermal or electrical energy for statistical purposes or to generate reports of thermal energy generation and usage. The system can log temperature information over time and generate graphs and charts depicting thermal energy production or consumption. For billing or metering purposes, the changes in thermal energy can be used to calculate an amount to be charged to a user. For example, the system can charge a user based on the decrease in thermal energy attributed to hot water consumption, or the system can charge a user one rate for hot water consumed during periods of the day when hot water can be produced from solar energy and a second rate for hot water consumed during periods of the day when hot water must be produced from backup sources such as electric or gas heating.

The embodiments described herein are merely exemplary, and other embodiments are possible. For example, input to controller 3 from the elongated temperature sensor 2 can be readily combined with input from other sensors. One or more absolute temperature sensors can be provided throughout the system. In one embodiment, a relatively fast rise in temperature as measured by an absolute temperature sensor connected to hot water outlet 5 can indicate hot water consumption. In another embodiment, a relatively high temperature as measured by an absolute temperature sensor connected to a solar collector portion of the hot water system can indicate thermal energy production attributable to solar heating sources.

1. A system comprising:
a hot water storage tank;
an elongated temperature sensor within the hot water storage tank and vertically oriented over a substantial portion of the vertical height of the storage tank; and
a controller forming an electrical circuit with the temperature sensor for processing measurements from the temperature sensor.

2. The system of claim 1, wherein the elongated temperature sensor is a U-shaped electrically conducting wire.

3. The system of claim 1, wherein the elongated temperature sensor includes a coiled electrically conducting wire.

4. The system of claim 1, wherein the elongated temperature sensor is configured to operate in water with an average resistance of at least 50 ohms.

5. The system of claim 1, wherein the substantial portion of the vertical height of the storage tank is at least 80% of the vertical height of the storage tank.

6. The system of claim 1, further comprising a passive geyser solar system connected to the storage tank.

7. A computer-based method comprising:
measuring a first average fluid temperature in a hot water storage tank with an elongated temperature sensor at a first time, wherein the elongated temperature sensor is within the hot water storage tank and vertically oriented over a substantial portion of the vertical height of the storage tank;
measuring a second average fluid temperature in the hot water storage tank with the elongated temperature sensor at a second time;
determining a rate of change of average temperature of the fluid in the hot water storage tank based on the first and second average fluid temperatures and the first and second times; and
determining a change in thermal energy in the fluid in the hot water storage tank based on the calculated rate of change of average temperature of the fluid.

8. The method of claim 7, further comprising measuring a sequence of average fluid temperatures based on a configurable time period.

9. The method of claim 7, further comprising identifying the change in thermal energy as being from a solar contribution when the change is greater than zero and less than a positive threshold change.

10. The method of claim 7, further comprising identifying the change in thermal energy as a backup contribution when the change is greater than a positive threshold change.

11. The method of claim 7, further comprising identifying the change in thermal energy as an ambient loss when the change is less than zero and greater than a negative threshold change.

12. The method of claim 7, further comprising identifying the change in thermal energy to a hot water consumption when the change is less than a negative threshold change.

13. The method of claim 7, further comprising:
learning and storing a typical energy loss at a known tank temperature and a known ambient temperature;
adjusting an attribution of the change in thermal energy based on the typical energy loss.

14. The method of claim 7, further comprising learning and storing a typical change in thermal energy when hot water is produced and consumed simultaneously.

15. The method of claim 7, further comprising displaying a result.

16. The method of claim 7, further comprising providing a report.

17. A method comprising:
providing a temperature sensor for use within a water storage tank, the sensor being elongated and having a length equivalent to a substantial portion of the vertical height of the storage tank; and
coupling the sensor to a controller for measuring average temperature in the tank.

18. The method of claim 17, wherein the providing includes providing a temperature sensor as a retrofit to an existing storage tank.

19. The method of claim 18, wherein the temperature sensor is compatible with a passive geyser solar system connected to the existing storage tank.

20. The method of claim 17, wherein the elongated temperature sensor includes a U-shaped electrically conducting wire.
